(19) United States
(12) Patent Application Publication
(10) Pub. No.: US 2023/0316283 A1
(43) Pub. Date: Oct. 5, 2023

(54) SYSTEMS AND METHODS FOR MERCHANT INTEGRATION TO TRACK ORDERS AND SHIPMENT STATUS

(71) Applicant: JPMORGAN CHASE BANK, N.A., New York, NY (US)

(72) Inventors: Raghu VUDATHU, Downingtown, PA (US); Gerardo GEAN, Plano, TX (US); Sudharsan SELVAKUMAR, Irving, TX (US); Aditya CHEBIYYAM, McKinney, TX (US); Rajitha DISSANAYAKE, Frisco, TX (US)

(21) Appl. No.: 18/193,174

(22) Filed: Mar. 30, 2023

Related U.S. Application Data
(60) Provisional application No. 63/362,352, filed on Apr. 1, 2022.

(51) Int. Cl. G06Q 20/40

(52) U.S. Cl. CPC G06Q 20/4016

(57) ABSTRACT

A method for merchant authorization and transaction notification may include: receiving, financial institution computer program for a financial institution and from a merchant system, a transaction involving a customer of the financial institution; authorizing, by the financial institution computer program, the transaction; communicating, by the financial institution computer program, a notification to a messaging address associated with the customer, transaction information and an option to report the transaction as unauthorized; receiving, by the financial institution computer program and from an electronic device associated with the customer, a report that the transaction was unauthorized; notifying, by the financial institution computer program, the merchant system that the transaction was unauthorized, wherein the merchant system is configured to cancel the transaction; and executing, by the financial institution computer program, a fraud prevention action with a financial instrument used to conduct the transaction in response to the report that the transaction was unauthorized.

### RELATED APPLICATIONS

This application claims priority to, and the benefit of, U.S. Provisional Patent Application Ser. No. 63/362,352, filed Apr. 1, 2022, the disclosure of which is hereby incorporated, by reference, in its entirety.

### BACKGROUND OF THE INVENTION

### 1. Field of the Invention

Embodiments generally relate to systems and methods for merchant integration to track orders and shipment status.

### 2. Description of the Related Art

After a customer makes an online purchase with a credit card issued by a financial instrument, the customer's payment experience with the financial institution ends there. The customer must use other tools, such as those provided by the merchant, by the shipper, etc. to determine the status of the purchase.

### SUMMARY OF THE INVENTION

Systems and methods for merchant integration to track orders and shipment status are disclosed. In one embodiment, a method for initiating order tracking may include: (1) receiving, at a financial institution computer program executed by a financial institution electronic device for a financial institution and from a merchant backend, transaction data for a transaction between a customer and a merchant; (2) authorizing, by the financial institution computer program, the transaction; (3) sending, financial institution computer program, the transaction data to an order tracking system computer program for the financial institution; (4) receiving, by the order tracking system computer program, a digital receipt for the transaction; (5) matching, by the order tracking system computer program, the digital receipt to the transaction; and (6) fetching, by the order tracking system computer program, a transaction status for the transaction from the merchant.

In one embodiment, the digital receipt may be received from the merchant backend.

In one embodiment, the digital receipt may be received from a customer electronic device. In another embodiment, the digital receipt may be uploaded by the customer to the order tracking system computer program.

In one embodiment, the digital receipt may be matched to the transaction using a transaction date, a transaction price, and/or the merchant.

According to another embodiment, a method for merchant authorization and transaction notification may include: (1) receiving, financial institution computer program for a financial institution and from a merchant system, a transaction involving a customer of the financial institution; (2) authorizing, by the financial institution computer program, the transaction; (3) communicating, by the financial institution computer program, a notification to a messaging address associated with the customer, transaction information and an option to report the transaction as unauthorized; (4) receiving, by the financial institution computer program and from an electronic device associated with the customer, a report that the transaction was unauthorized; (5) notifying, by the financial institution computer program, the merchant system that the transaction was unauthorized, wherein the merchant system is configured to cancel the transaction; and (6) executing, by the financial institution computer program, a fraud prevention action with a financial instrument used to conduct the transaction in response to the report that the transaction was unauthorized.

In one embodiment, the receipt of the report that the transaction was unauthorized may be received within a predetermined period of time.

In one embodiment, the messaging address may include a SMS address or an email address.

In one embodiment, the transaction information may include a merchant, a cost, a date and time, and a good or service description.

In one embodiment, the fraud prevention action may include closing an account associated with the financial instrument.

In one embodiment, the fraud prevention action may include disabling the financial instrument.

In one embodiment, the communication may be sent to the messaging address for the customer for transactions occurring in a period between a credit card being mailed and acknowledgment of customer receipt of the credit card.

According to another embodiment, a non-transitory computer readable storage medium may include instructions stored thereon, which when read and executed by one or more computer processors, cause the one or more computer processors to perform steps comprising: receiving, from a merchant system, a transaction involving a customer of a financial institution; authorizing the transaction; communicating a notification to a messaging address associated with the customer, transaction information and an option to report the transaction as unauthorized; receiving, from an electronic device associated with the customer, a report that the transaction was unauthorized; notifying the merchant system that the transaction was unauthorized, wherein the merchant system is configured to cancel the transaction; and executing a fraud prevention action with a financial instrument used to conduct the transaction in response to the report that the transaction was unauthorized.

In one embodiment, the receipt of the report that the transaction was unauthorized may be received within a predetermined period of time.

In one embodiment, the messaging address may include a SMS address or an email address.

In one embodiment, the transaction information may include a merchant, a cost, a date and time, and a good or service description.

In one embodiment, the fraud prevention action may include closing an account associated with the financial instrument.

In one embodiment, the fraud prevention action may include disabling the financial instrument.

In one embodiment, the communication may be sent to the messaging address for the customer for transactions occurring in a period between a credit card being mailed and acknowledgment of customer receipt of the credit card.

According to another embodiment, a method for providing a real-time status update for an order may include: (1) receiving, by an order tracking system computer program and from a customer electronic device, a request for a status for a customer order; (2) fetching, by the order tracking system computer program, the status from a merchant associated with the order or a delivery provider that is delivering the order; and (3) returning, by the order tracking system computer program, the status to the customer electronic device.

According to another embodiment, a method for periodic status update for an order may include: (1) initiating, by an order tracking system computer program, a background update for an order status from a merchant or from a delivery provider; (2) determining, by the order tracking system computer program, that the order status has changed from a prior order status; and (3) providing, by the order tracking system computer program, the order status to a customer electronic device.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for merchant integration to track orders and shipment status according to an embodiment;

FIG. 2 depicts a method for merchant integration to track orders and shipment status according to an embodiment;

FIG. 3 depicts a method for merchant authorization and transaction notification according to an embodiment;

FIG. 4 depicts a method for providing a real-time status update according to an embodiment;

FIG. 5 depicts a method for periodic status update according to an embodiment;

FIG. 6 depicts an exemplary computing system for implementing aspects of the present disclosure.

### DETAILED DESCRIPTION OF PREFERRED EMBODIMENTS

Embodiments are directed to systems and methods for merchant integration to track orders and shipment status.

In embodiments, when a customer uses a payment method provided by a financial institution or similar to purchase a product or service from a merchant, the financial institution may automatically track the order and provide information on the order including shipment tracking, until the product is delivered, where applicable. The merchant may be onboarded with the financial institution, and the financial institution may receive additional details on the order, from merchants for tracking purposes.

The payment method may include a credit card, a debit card, a tokenized card, a stored value card, rewards points, single-use cards, virtual cards, etc. In one embodiment, the payment may be split among a plurality of payment methods. As long as one of the payment methods is associated with or issued by the financial institution, the order may be tracked.

In embodiments, the financial institution may provide a dashboard view of such orders and provide consolidated order information and status to customer across all of their payment methods with the financial institution.

Tracking information may be refreshed on-demand, as customers access the tracking details, and/or may be periodically refreshed. For example, tracking information may be refreshed on-demand in the financial institution application, or directly on any of the registered customer electronic devices the customer uses to perform their transactions, Notifications may be sent to customers when an order status changes.

Embodiments may facilitate fraud identification by the customer as transaction details may include order information. Thus, customers may match transactions to valid orders placed and identify fraudulent transactions.

In embodiments, because onboarded merchants provide the financial institution with transaction details for transactions, including an identification of the good purchase, the financial institution has greater access to product (SKU) level information on customer purchases.

Embodiments may coordinate a customer's purchases across multiple financial instruments, accounts, etc. For example, purchases made using a customer's personal and business accounts may be aggregated and presented together in one interface. Thus, tracking information for all transactions involving an account associated with the customer may be presented.

In one embodiment, machine learning may be used to identify the accounts, transaction types, etc. that the customer may want to include or not include in the aggregated report.

In one embodiment, the customer may opt out of having certain transactions, transactions involving a certain card or account, etc. tracked as is necessary and/or desired.

In one embodiment, the financial institution may make the order tracking service available to third parties, such as third party partners, other financial institutions, etc. The third parties may also share their data with the order tracking system as is necessary and/or desired.

In embodiments, the customer may order items that require delivery, items that do not require delivery (like a service or digital content), and items that are picked up. For pickup and digital content/services, the order tracking service may interface with the merchant to identify the order and delivery status. For items that need delivery, the order tracking service may interface with the merchant to identify delivery updates (e.g., where the merchant fulfills delivery) or with third party delivery suppliers (e.g., where the merchant uses a third party for delivery).

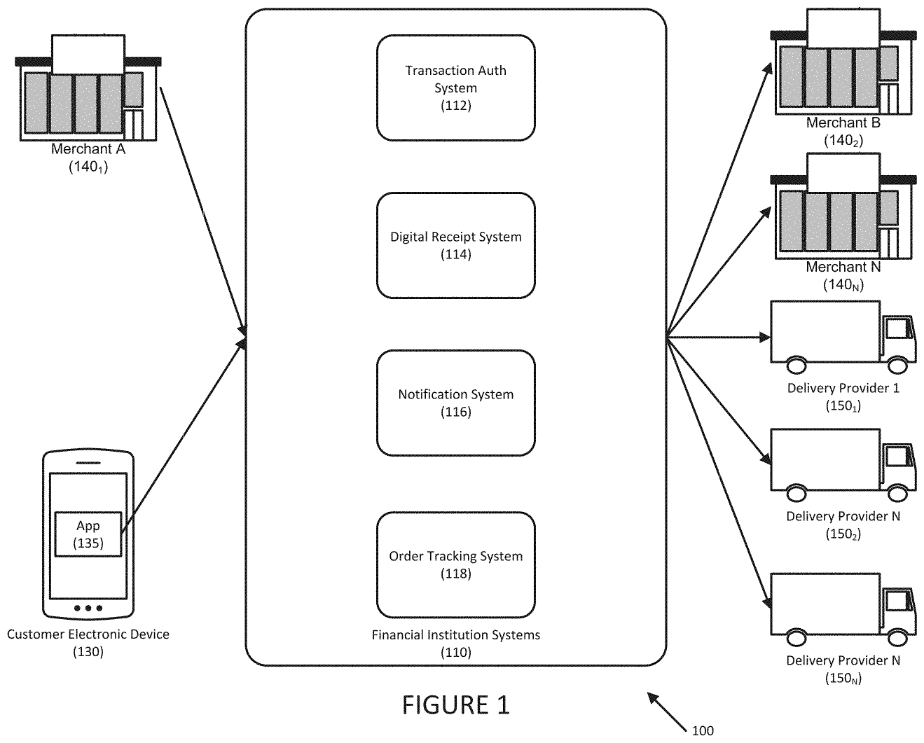

Referring to FIG. 1, a system for merchant integration to track orders and shipment status is disclosed according to an embodiment. System 100 may include financial institution systems 110 for a financial institution that may include transaction authorization system 112, digital receipt system 114, notification system 116, and order tracking system 118. A customer may conduct a transaction for a good or service with a merchant (e.g., merchant 1401) directly or using customer electronic device 130, and may access order details using application 135, such as a mobile or web application, on customer electronic device 130.

The financial institution may include any organization that can process a financial transaction, such as a bank, a financial aggregator, a Financial Technology (FinTech) entity, a payment network provider, etc.

Transaction authorization system 112 may provide transaction authorization services for a transaction. As part of its authorization process, transaction authorization system 112 may notify a customer of any transactions involving a financial instrument issued by the financial institution.

Digital receipt system 114 may receive and maintain digital receipts for transactions involving customers of the financial institution.

Order tracking system 118 may interface with merchants 140 (e.g., 1401, 1402, . . . 140N), delivery providers 150 (e.g., 1501, 1502, . . . 150N), etc. and may provide updates to customers via app 135.

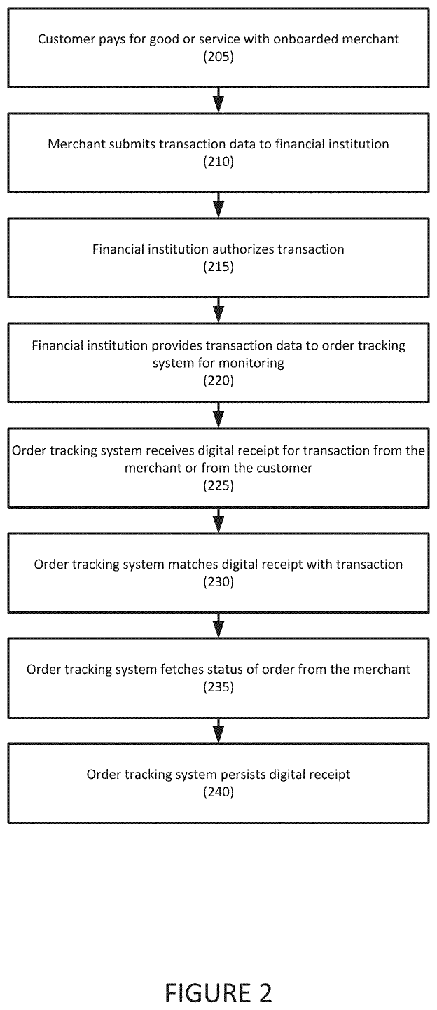

Referring to FIG. 2, a method for merchant integration to track orders and shipment status is disclosed according to an embodiment.

In step 205, a customer may shop for a product from a merchant that has been onboarded or registered with a financial institution or similar, and may pay for the product using a payment method issued by or registered to the financial institution. For example, the order may be placed online, at a merchant point of sale.

In step 210, as part of the transaction approval process, the merchant may submit transaction data for the transaction to the acquirer, then to a Card Network (e.g., VISA or MasterCard), and ultimately to the issuing financial institution.

In step 215, the issuing financial institution may authorize the transaction by providing the transaction data to a transaction authorization process.

In step 220, the financial institution may provide the transaction data to an order tracking system for tracking and monitoring. The order tracking system may persist the metadata for the transaction, such as the transaction identifier, transaction amount, transaction date, payment card number, merchant identifier, etc.

In step 225, the order tracking system may receive a digital receipt for the transaction. In one embodiment, the merchant may send a digital receipt for the transaction to the order tracking system. In another embodiment, the customer may also upload a receipt, digital or otherwise, to the order tracking system. For example, if the merchant sends a digital receipt by email or with the good or service, the customer may upload the digital receipt, a scan of a paper receipt, etc. to the order processing system.

In another embodiment, the financial institution may also upload a digital receipt for the transaction based on transaction details it may have (e.g., merchant, card number, date, amount, description, etc.). The financial institution may also use its relationships with the onboarded merchants to obtain digital receipts from the merchant and upload the digital receipts as is necessary and/or desired.

In step 230, the order tracking system may match the digital receipt to transaction based on details previously shared during the transaction authorization process. For example, the order tracking system may match the digital receipt to the transaction based on date, price, merchant, combinations, etc.

In step 235, for the matched transactions, the order tracking system may fetch the status of the order and may persist the status. In one embodiment, the order status may be fetched through a backend for the merchant.

In one embodiment, the order status may include an order status and/or delivery status, such as order placed, ready for shipment, shipped, delivered, cancelled, return started, refund issued, etc. in process, shipped, completed, etc.

In step 240, the order tracking system may persist the digital receipt with, for example, a digital receipt system, for storage and safe keeping. In one embodiment, the customer may access the digital receipt using, for example, a mobile application, a web browser, a digital wallet, etc.

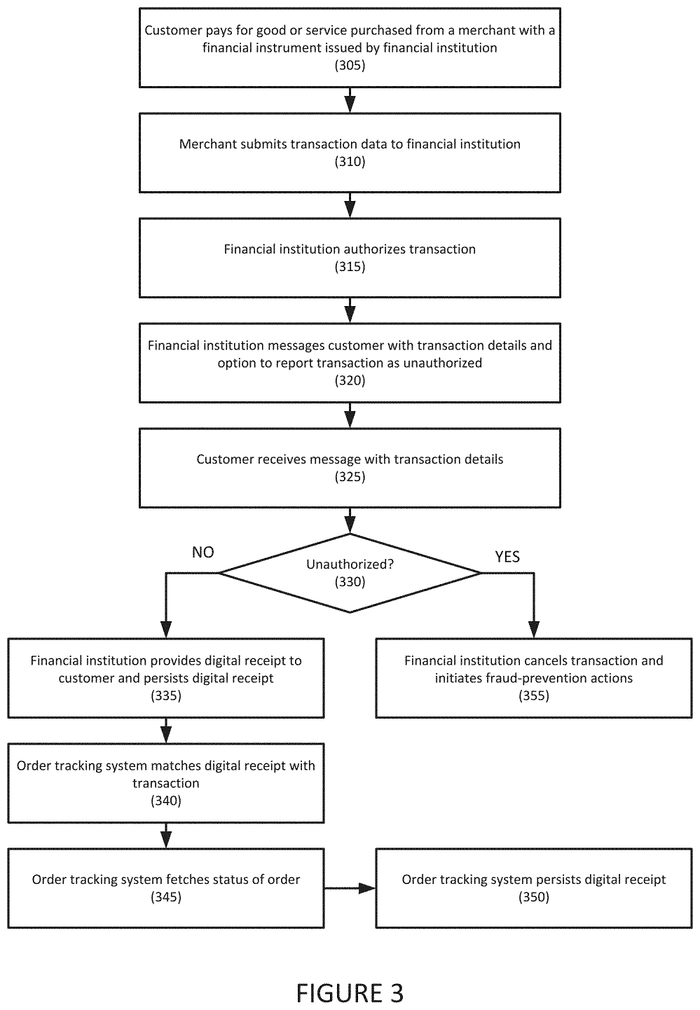

Referring to FIG. 3, a method for merchant authorization and transaction notification is disclosed according to an embodiment.

In step 305, a customer may select a good or service from a merchant and may pay for the good or service using a financial instrument issued by a financial institution. The merchant need not be onboarded or otherwise registered with the financial institution.

In step 310, as part of the transaction approval process, a merchant system for the merchant may submit transaction data for the transaction to the acquirer, then to a Card Network (e.g., VISA or MasterCard), and ultimately to the issuing financial institution.

In step 315, the issuing financial institution may authorize the transaction by providing the transaction data to a transaction authorization process.

In one embodiment, the merchant system may be notified that the transaction was authorized and may begin the order fulfillment process.

In step 320, the financial institution may message the customer at a registered messaging address (e.g., SMS, email, phone call, in-app message, etc.) with transaction information (e.g., one or more of a merchant, a cost, a date and time, good or service description, etc.) and option to report the transaction as an unauthorized transaction. For example, the message may be sent to a registered customer email address, registered customer electronic device, registered customer phone number, registered customer application etc., mobile/web app for display to the customer. The customer email address, customer electronic device, customer phone number, customer application, etc. may be registered as part of the Know Your Customer (KYC) process, may be part of the customer profile, etc.

In one embodiment, artificial intelligence and/or machine learning may be used to pre-validate transactions. The pre-validation may be based, for example, on the customer's transaction history, and the customer may only be notified if the transaction is predicted to be fraudulent.

In one embodiment, the notification process may not depend on whether the transaction is suspected to be a fraudulent transaction. For example, the customer may be notified of every transaction involving the financial instrument, regardless of cost, suspected fraud, etc. This may be helpful to a customer who may not have received a new credit card yet, may have lost a credit card or had it stolen, etc. Because all transactions are reported, the customer may be notified of a transaction that was not authorized so that the transaction may be stopped immediately.

In another embodiment, the customer may be notified of transactions in the period between a credit card being mailed to the customer, and the customer confirming receipt of the credit card. Thus, this may capture instances where the credit card was misdelivered, stolen, etc.

The basis for the notification and the communication channel may be configured by the customer.

In one embodiment, the message may include a button or similar graphical element to cancel the transaction or report the transaction as unauthorized.

In step 325, the customer may receive the message from the financial institution and, in step 330 may decide whether the transaction is unauthorized.

If the customer takes no action within a period of time, or indicates that the transaction was authorized, in step 335, the financial institution may provide a digital receipt to customer and may persist digital receipt.

In step 340, the order tracking system may match the digital receipt to transaction based on details previously shared during the transaction authorization process. For example, the order tracking system may match the digital receipt to the transaction based on date, price, merchant, combinations, etc.

In step 345, for the matched transactions, the order tracking system may fetch the status of the order and may persist the status. In one embodiment, the order status may be fetched through a backend for the merchant.

In step 350, the order tracking system may persist the digital receipt with, for example, a digital receipt system, for storage and safe keeping. In one embodiment, the customer may access the digital receipt using, for example, a mobile application, a web browser, a digital wallet, etc.

If the transaction was not authorized, in step 355, the financial institution may cancel the transaction with the merchant system and may initiate fraud-prevention actions, such as closing the credit card, issuing a new credit card, notifying the customer that the credit card has been disabled, etc.

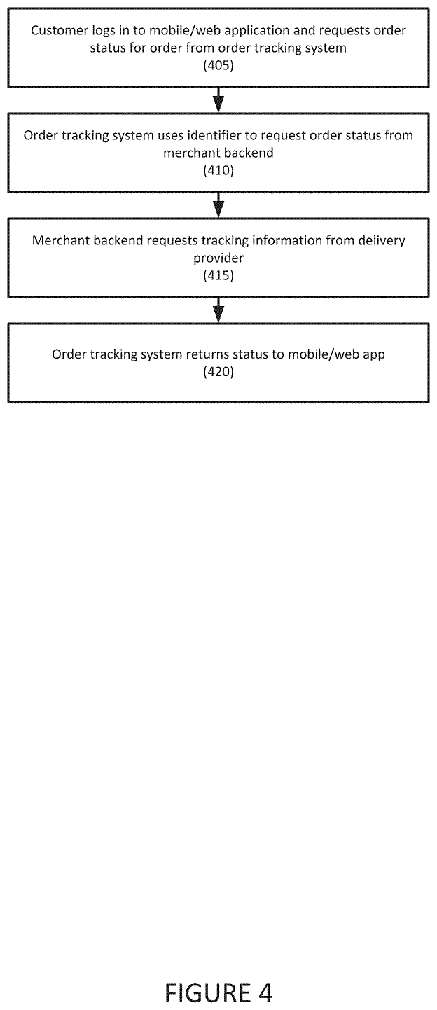

Referring to FIG. 4, a method for providing a real-time order status update is disclosed according to an embodiment. In step 405, using a mobile application or a web browser, a customer may request order status information from an order tracking system. For example, the customer may enter an order number, may select a digital receipt for the order, etc. The customer may also select a transaction in the customer's card transaction history and then be provided with the order details for the selected transaction.

In step 410, the order tracking system may use a unique identifier, such as an order number, to request an order status from a merchant backend associated with the merchant for the order.

In step 415, for shipped orders, the merchant backend may request tracking information from a delivery provider. For other orders, the merchant backend may return order pickup status or similar.

In step 420, the order tracking system may return the consolidated order/shipping information to the customer. For example, the order/shipping information may be sent to a registered customer email address, registered customer electronic device, registered customer phone number, registered customer application etc. mobile/web app for display to the customer. The customer email address, customer electronic device, customer phone number, customer application, etc. may be registered as part of the Know Your Customer (KYC) process, may be part of the customer profile, etc.

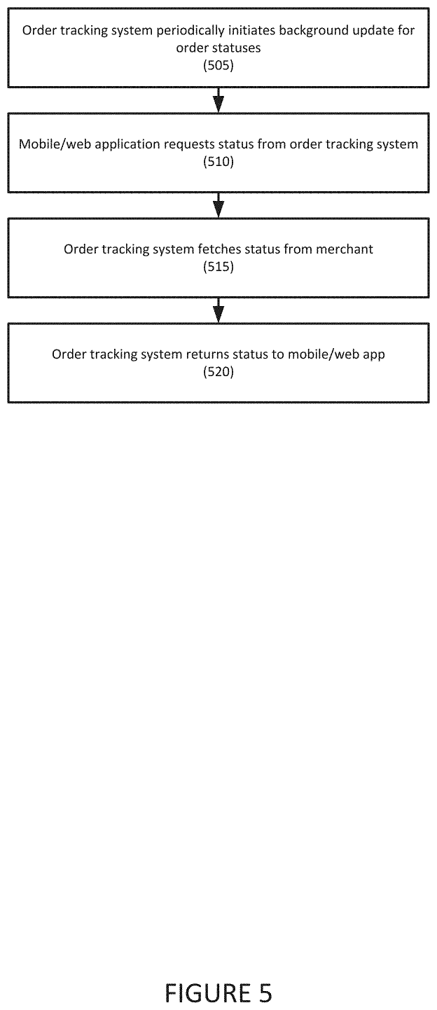

Referring to FIG. 5, a method for receiving periodic status update is disclosed according to an embodiment.

In step 505, an order tracking system may periodically initiate a background update to refresh the order status by fetching the current status from a merchant backend. For example, the order tracking system may provide identifiers for any open orders to the merchant backend.

In step 510, for applicable shipped orders, merchant backend may request tracking information through the delivery provider. The merchant backend may return the tracking information to the order tracking system.

In step 515, the order tracking system may retrieve the status from the merchant backend. For example, the merchant backed may expose an API so that the order tracking system can retrieve the status.

In step 520, the order tracking system may send notifications for any orders where the order or shipping status has changed. For example, the order tracking system may update a mobile application or a web browser, may send a message (e.g., SMS, email, etc.), may send a push notification (e.g., an in-app message), etc.

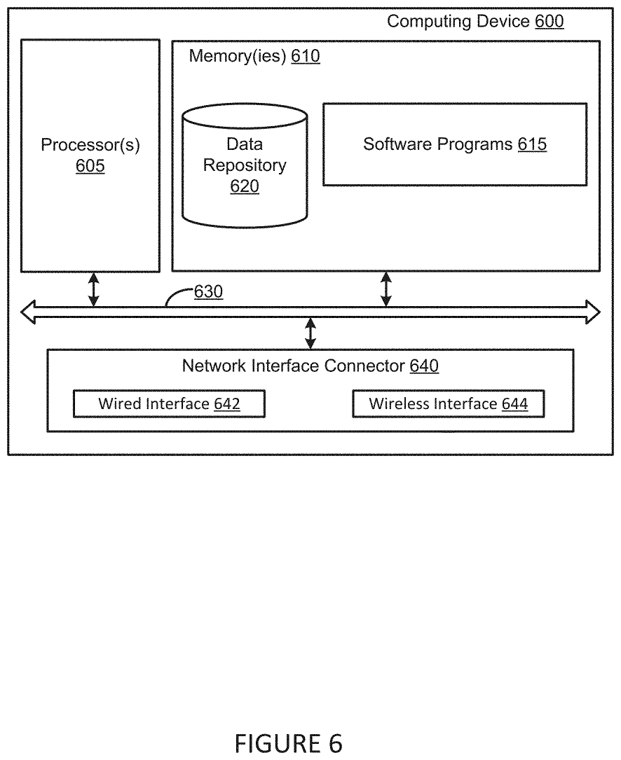

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for initiating order tracking, comprising:
receiving, at a financial institution computer program executed by a financial institution electronic device for a financial institution and from a merchant backend, transaction data for a transaction between a customer and a merchant;
authorizing, by the financial institution computer program, the transaction;
sending, financial institution computer program, the transaction data to an order tracking system computer program for the financial institution;
receiving, by the order tracking system computer program, a digital receipt for the transaction;
matching, by the order tracking system computer program, the digital receipt to the transaction; and
fetching, by the order tracking system computer program, a transaction status for the transaction from the merchant.

2. The method of claim 1, wherein the digital receipt is received from the merchant backend.

3. The method of claim 1, wherein the digital receipt is received from a customer electronic device.

4. The method of claim 1, wherein the digital receipt is uploaded by the customer to the order tracking system computer program.

5. The method of claim 1, wherein the digital receipt is matched to the transaction using a transaction date, a transaction price, and/or the merchant.

6. A method for merchant authorization and transaction notification, comprising:
receiving, financial institution computer program for a financial institution and from a merchant system, a transaction involving a customer of the financial institution;
authorizing, by the financial institution computer program, the transaction;
communicating, by the financial institution computer program, a notification to a messaging address associated with the customer, transaction information and an option to report the transaction as unauthorized;
receiving, by the financial institution computer program and from an electronic device associated with the customer, a report that the transaction was unauthorized;
notifying, by the financial institution computer program, the merchant system that the transaction was unauthorized, wherein the merchant system is configured to cancel the transaction; and
executing, by the financial institution computer program, a fraud prevention action with a financial instrument used to conduct the transaction in response to the report that the transaction was unauthorized.

7. The method of claim 6, wherein the receipt of the report that the transaction was unauthorized is received within a predetermined period of time.

8. The method of claim 6, wherein the messaging address comprises a SMS address or an email address.

9. The method of claim 6, wherein the transaction information comprises a merchant, a cost, a date and time, and a good or service description.

10. The method of claim 6, wherein the fraud prevention action comprises closing an account associated with the financial instrument.

11. The method of claim 6, wherein the fraud prevention action comprises disabling the financial instrument.

12. The method of claim 6, wherein the notification is sent to the messaging address for the customer for transactions occurring in a period between a credit card being mailed and acknowledgment of customer receipt of the credit card.

13. A non-transitory computer readable storage medium, including instructions stored thereon, which when read and executed by one or more computer processors, cause the one or more computer processors to perform steps comprising:
receiving, from a merchant system, a transaction involving a customer of a financial institution;
authorizing the transaction;
communicating a notification to a messaging address associated with the customer, transaction information and an option to report the transaction as unauthorized;
receiving, from an electronic device associated with the customer, a report that the transaction was unauthorized;
notifying the merchant system that the transaction was unauthorized, wherein the merchant system is configured to cancel the transaction; and
executing a fraud prevention action with a financial instrument used to conduct the transaction in response to the report that the transaction was unauthorized.

14. The non-transitory computer readable storage medium of claim 13, wherein the receipt of the report that the transaction was unauthorized is received within a predetermined period of time.

15. The non-transitory computer readable storage medium of claim 13, wherein the messaging address comprises a SMS address or an email address.

16. The non-transitory computer readable storage medium of claim 13, wherein the transaction information comprises a merchant, a cost, a date and time, and a good or service description.

17. The non-transitory computer readable storage medium of claim 13, wherein the fraud prevention action comprises closing an account associated with the financial instrument.

18. The non-transitory computer readable storage medium of claim 13, wherein the fraud prevention action comprises disabling the financial instrument.

19. The non-transitory computer readable storage medium of claim 13, wherein the notification is sent to the messaging address for the customer for transactions occurring in a period between a credit card being mailed and acknowledgment of customer receipt of the credit card.
